(19) United States
(12) Patent Application Publication
(10) Pub. No.: US 2015/0302053 A1
(43) Pub. Date: Oct. 22, 2015

(54) SYSTEM AND METHOD FOR ONLNE BRAND PROTECTION AND REGISTRY

(71) Applicant: DomainSkate

(72) Inventors: David Mitnick, New York, NY (US); Howard Greenstein, Suffern, NY (US); Peter Kaminski, San Francisco, CA (US)

(21) Appl. No.: 14/692,180

(22) Filed: Apr. 21, 2015

Related U.S. Application Data
(60) Provisional application No. 61/982,226, filed on Apr. 21, 2014.

(51) Int. Cl. G06F 17/30; H04L 12/26

(52) U.S. Cl. CPC G06F 17/30424; H04L 43/045

(57) ABSTRACT

A computer-implemented domain name registration monitoring system and method is described in which a target name is monitored against new Internet domain name registrations. A target name is received from a user computing device and variations of the target name may be generated before a comparison is made against a data structure containing active domain name registrations. An interactive dashboard may be provided by an application server computing device for presenting matches to the user along with additional background information concerning the registrations.

### PRIORITY CLAIM

This application claims priority to U.S. Provisional Patent Application No. 61/982,226, filed Apr. 21, 2014 and titled, “SYSTEM AND METHOD FOR ONLINE BRAND PROTECTION AND REGISTRY,” the contents of which is incorporated by reference in its entirety.

### BACKGROUND

In embodiments, the present invention provides an enhanced system that enables trademark, business, and/or brand owners to monitor domain registrations and attempts by others to registrar domains that could be confusingly similar to the trademark. In embodiments, the system comprises a multi-faceted user interface, which may be accessed from any computing device, and a novel search system that searches for complex variations of the domain name of the types that might be sought after by domain squatters, competitors, or anyone looking to capitalize on the user's trademark. In embodiments, the search system takes only certain parts of registered domains and searches against existing or attempted registrations to get the best results for the user's trademark or brand name. In embodiments, the user may be provided with a mechanism to perform additional tasks related to the domain such as registering the domain with the Trademark Clearinghouse, or registering variations of the domain name without exiting the system.

When visiting and utilizing Internet-based web sites, businesses and consumers have grown accustomed to certain so-called top-level domains such as “.com,” “.net,” and “.org,” among others, within which, individual domain names are assigned. For example, www.uspto.gov is a domain within the “.gov” top-level domain.

Allocation and registration of domain names and top-level domains is generally handled by the Internet Corporation For Assigned Names and Numbers (“ICANN”), a non-profit corporation in charge of the domain name naming and numbering system that coordinates the Internet's global domain name system. ICANN's primary role/responsibility is to ensure the stability of the Internet and develop policies for the governance of the Internet.

Some domains are allocated on a first-come-first-serve basis, while others require verification before being assigned. For example, domains in the “.edu” top-level domains may be registered only by educational institutions. The “.tv” top-level domain is available to anyone who registers, without verification of an association with the television industry.

Trademark owners frequently seek to register domain names that correspond to their individual trademarks. For example, Macy's, Inc. is the registrant of www.macys.com so that customers looking for the company online can easily locate the Macy's web site. However, parties other than the trademark holder sometimes register (or attempt to register) domain names that are similar to well-known trademarks. There may be legitimate reasons for such domain registrations, particularly where the registered name is one that is commonly used in other areas (e.g., apple.com or applestore.com and apple-farmer.net) and therefore is not exclusively held by the trademark owner. However, there may also be malicious reasons for registering domain names that include a famous trademark or brand name such as to capitalize on the name recognition of the brand name, to generate traffic to a web site, or to sell users unrelated goods or services. In extreme circumstances, a party may be actively seeking to harm a competitor by securing a domain.

Recently, ICANN initiated a program for the registration of so-called generic top-level domains, opening the door to as many as 1,400 new “top-level domains” such as .hotel, .store, .law, .music, .home, .book, blog, .club, .nyc, and more. The top-level domain expansion has been promoted by ICANN as creating a more balanced and equitable Internet stakeholder community that exists in numerous registries and in many different languages.

ICANN, which established the gTLD program, also established what is known as the Trademark Clearinghouse (“TMCH”). The TMCH is a centralized database of verified trademarks. Those verified trademarks can then be used to gain a “right of first refusal” and prevent other third parties from registering domain names identical to that registered trademark in new gTLD registries. Trademark owners are able to submit trademark data for incorporation into the TMCH database. That data is then verified and the user is provided with a unique authentication key.

Once verified, the registrant is given first priority to register their trademarked name during a pre-registration period known as a “sunrise period.” For example, if Hilton were to register in the TMCH database, it would have priority to register hilton.hotel when the .hotel gTLD opened, or hilton.travel were a .travel gTLD to open. Having a trademark in the TMCH is the minimum condition to be able to register your corresponding domain name during the sunrise period.

A second benefit is available to TMCH registrants. When someone wishes to register a domain name that matches your trademark record in the TMCH, the TMCH will alert the attempted registrant of your rights, which must be acknowledged by the attempted registrant before completing registration. If registration is completed, the TMCH registrant will be notified that a domain has been registered with their trademark. Registrants are immediately aware of any possible infringement of the trademark in a new gTLD.

However, registering with the TMCH and verifying trademark ownership can be a cumbersome and time-consuming procedure, particularly where an entity owns numerous trademarks. Additionally, the TMCH only watches for exact matches and simple variations of a trademark. Thus, variations on the trademark that may be registered would not be subject to the terms of the TMCH.

Further still, the TMCH does not suggest alternate domains that a trademark owner may wish to register, either to directly exploit or for defensive purposes. For example, Hilton Hotels may want to register hillton.hotel to block another user from trafficking in simple misspellings of its name. The TMCH would not suggest or aid in registering hillton.hotel.

Accordingly, there is a need for a domain warning system and method for alerting trademark owners of attempts to register complex domain variations.

Accordingly, there is a further need for a domain warning system and method that enables the trademark holder to register domain variations form within the warning system itself, and provide additional suggestions of domains to register defensively or investigate defensively in order to ensure that the trademark or brand name is not being used inappropriately and/or without authorization.

Accordingly, there is a further need for a domain warning system and method that integrates the benefits of the TMCH with an enhanced warning system that searches for complex variants of a domain, and provides the user with the option to register that domain within the system.

Accordingly, there is a further need for a domain warning system and method that integrates the benefits of the TMCH with an enhanced warning system that searches for complex variants of a domain, and provides the user with the option to register that domain within the system.

### BRIEF DESCRIPTION OF THE DRAWINGS

The features and advantages of the present disclosure will be more fully understood with reference to the following detailed description when taken in conjunction with the accompanying figures, wherein:

FIG. 1 is a flowchart showing a system and method of monitoring a trademark or domain and reporting results to a user according to embodiments of the present invention.

FIG. 2 is a flowchart showing the creation of part of a domain name database according to embodiments of the present invention.

### SUMMARY

In embodiments, a computer-implemented method for monitoring domain name registrations is disclosed in which a domain name data structure is created and written to a server computing device. A target name may be received from a remote computing device, after which a plurality of variations of said target name are generating. Lastly, using an application server computing device, a determination is made whether any entries in the active domain name data structure qualify as a match to target name.

In alternate embodiments, the step of generating an active domain name data structure further includes receiving one or more zone files over a network connection, parsing said zone files to identify active domain names in said zone files, and transferring the list of active domain names to a server computing device.

In embodiments, the domain name data structure is a hash table or a database. In further embodiments, the determining step incorporates data concerning the usage of said target name. Variations of the target name may be generated by considering one of: characters in proximity to those of said target name, swapped characters, multiples of single characters in said target name, singles of multiple letters in said target name, and transposed letters. Variations may also be generated using an artificial intelligence module, which may be a part of the application server. Alerts may be generated in response to the determining step by the application server, which may also present an interactive dashboard to the user that includes additional information concerning the results such as an image of the current landing page for each of the results, a malware threat assessment concerning each of the results, and the registrant of each of the results.

In an alternate embodiment, a system for monitoring domain name registrations is disclosed including a domain name data structure stored on a server computing device, an application server computing device in communication with a remote computing device, wherein the application server computing device is configured to receive a target name from the remote computing device over a network, and a processor for comparing entries in the domain name data structure with variations of said target name.

### DETAILED DESCRIPTION

Detailed embodiments of the disclosure are disclosed herein; however, it is to be understood that the disclosed embodiments are merely exemplary and may be embodied in various forms. Therefore, specific details disclosed herein are not to be interpreted as limiting, but merely as a representative basis for teaching one skilled in the art to variously employ the disclosure in virtually any appropriate manner, including employing various features disclosed herein in combinations that might not be explicitly disclosed herein.

In embodiments, user accessing the system for the first time will provide bibliographic information related to the trademarks and/or domains at issue, and information about the company itself. Screen shots of an exemplary user interface are shown in Appendix A hereto.

Access to the system may by a client device, which may be any computing device that can connect to a remote server such as, for example, a personal computer, web browser, smartphone, tablet computer, enhanced television device, or the like. The client device may utilize a conventional web browser, dedicated application or mobile app, or other interface.

In embodiments, a dashboard may be presented to the user, displaying relevant information in one location. Screen shots of an exemplary dashboard are shown in Appendix A, hereto. Information in the dashboard may include the searched for term or domain name, the variants that were found by the system, links to the website associated with that domain name along with a link to the WHOIS record for the registrant of that domain name, the date and time that the record was found on the system, metadata associated with that domain name, link to a page where domain variants that are not registered can be reviewed and possibly registered by the user, along with other relevant information related to that domain registration.

In embodiments, the user may be prompted to enter one or more trademarks or domain names for monitoring. These trademarks or domain names may then be entered into a customer domain name database. In further embodiments, users are enabled to enter multiple domains that may be associated with the brand. For example, if the user were Macy's, the user may be enabled to enter not only the primary domain—www.macys.com—but also www.macysny.com and www.macysdesigns.com. Such an arrangement provides additional convenience to the user by allowing for monitoring of multiple related brands within a single environment.

In embodiments, the system of the present invention may comprise a client-server arrangement, including one or more servers, a client device for accessing the server, and domain name database.

In embodiments, the server may be any type of web server or other server that has the ability to query a remote database and deliver results to a client device. In embodiments, the system may comprise a domain data server; application server; content management system; a web server that hosts the marketing website; a Zonefile Archive Volume; and a SQL database instance for administration and customer data.

In embodiments, the domain data server may be used as part of the domain name matching processes. Component processes may include zonefile retrieval; zonefile holding; zonefile archive; zonefile parsing; second-level domain (SLD) hash tables; a variant generation process; and the matching process itself. In embodiments, an SLD hash table for each top-level domain (TLD) tracked by the system is provided.

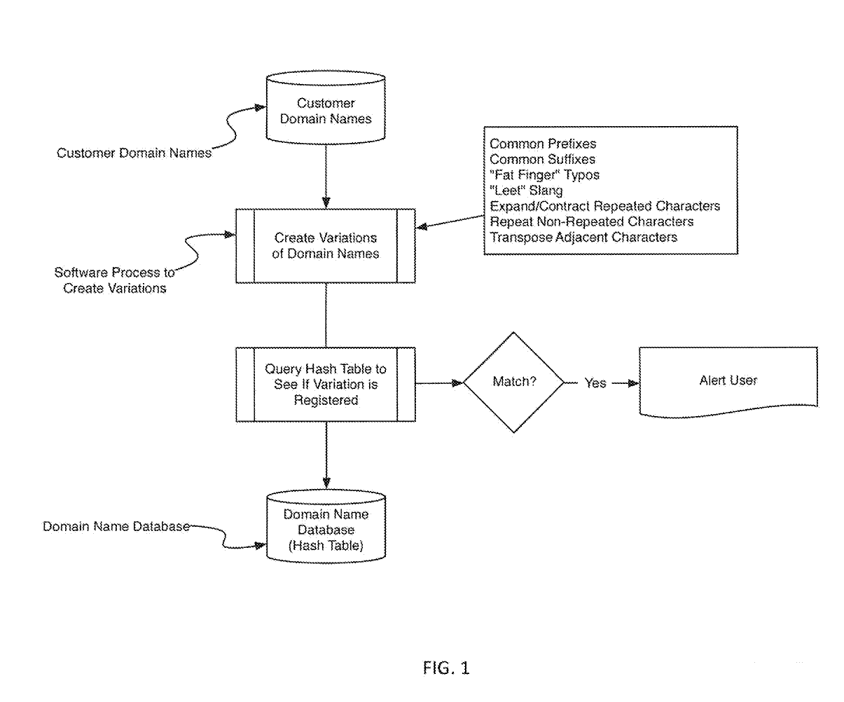

FIG. 1 below is a flowchart showing an exemplary system and method of monitoring a trademark or domain and reporting results to a user.

As shown in FIG. 1, a customer domain name database may include organized data related to: (1) domains and trademarks that are being monitored, (2) information about the owners of the domains and trademarks being monitored, and (3) information about the monitored domains that relate to its use and presence in the marketplace and how it is being used by those domain holders and websites.

In embodiments, as shown in FIG. 1, the system may create variations of the monitored domain names to capture not only exact matches and simple variations, but also more complex variations.

In embodiments, the system of the present invention may include software for generating variations of the monitored domains, which software may be run on the remote server. In embodiments, software for generating variations may incorporate any number of techniques beyond exact searches and simple permutations, including, for example:

(1) fatfinger—variations around the name based on keyboard key proximity

(2) leet—“hacker” style character substitutions—a e l o s t b ->4 3 1 0 5 7 8

(3) undouble—replace double letters with single letters

(4) transposition—replace a/e, e/a, e/r, and the/teh

(5) swap—swap adjacent characters, for the whole string

In embodiments, the system may be incorporate artificial intelligence or other logic that is responsive to domain registration patterns. Such artificial intelligence or logic may take information (e.g., existing search results, user input, patterns gleaned from domain registration datasets, or other sources) and formulate new domain variations to search for on behalf of users of the system.

In embodiments, variations may be generated only on part of the domain name, or search against registrations (or attempts) made on only a part of the domain. For example, there are often situations where a trademark or brand name is composed of two or more terms. An example of this is the trademark(s) BURGER KING or APPLE COMPUTER or THE HOME DEPOT. In such situations it may be necessary to parse the trademarks or domain names into individual pieces, transpose the terms, and/or focus on individual elements that may be more relevant to users (e.g., susceptibility to cyber-squatting).

The foregoing is meant only to be illustrative and other techniques for generating domain variations may be incorporated as domain squatters and others refine their techniques.

In embodiments, the software for generating variations may include techniques for limiting false positives and other “noise” words that need not be searched. For example, for short domains such as JVC or NCAA, it may not be useful to generate “jumble” style results. Accordingly, in embodiments, the software for generating variations may be programmed to consult a dictionary of common acronyms and if the monitored domain is an acronym, and is less than, for example, six characters, to omit certain variations and only perform searches against s subset of variations.

For example, if the monitored domain is NCAA, the software for generating variations may confirm that the term is an acronym, below a predetermined length, and thus limit the searches performed to, for example, identical words, words using NCAA as a prefix, words using NCAA as a suffix, and the like.

In embodiments, the software for generating variations may incorporate feedback from the user as to the relevance of certain variations. For example, if the user enters DinosaurCookbook or Dinosaur and Cookbook, the system will ask the user for information as to the relevance of the terms and to provide context for how best to categorize the search terms. For example, in the present example, the user could focus the search on the individual terms “dinosaur” and “cookbook.” This will improve the system process by making sure that the system reads the compound term “cookbook” correctly and also parses out the term “dinosaur,” which in this case, may comprise the most significant search variable in the term.

In embodiments, the software for generating variations may be coupled to a storage medium (e.g., hard disk, flash memory, etc.) for storing the domain variations, either for a short term or permanently.

In embodiments, the system further comprises a domain name database, which may be an organized collection of data related to: (1) existing domain name registrations and attempted registrations, (2) information relating to customer trademarks and domains, and (3) other data related to domain name registrations.

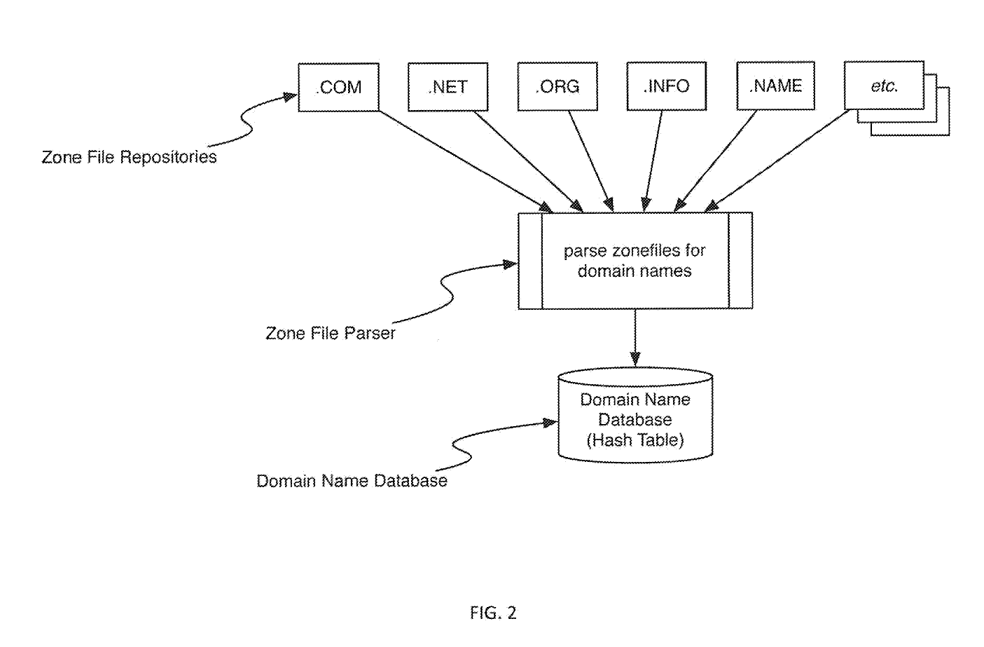

Referring to FIG. 2, an exemplary flowchart shows the creation of part of a domain name database according to embodiments of the present invention.

In embodiments, the system may conducts a tiered search that is tied either to the brand name or trademarks that the user puts into the system or domain names that the user puts into the system that are closely related to or used with said brand names or trademarks. The user may also be offered keywords or additional search terms (that are input or placed into the system via a drop-down menu) to help increase the accuracy of the search. The user can interface with the search results that are part of the domain name database and that comprise the search results for that particular trademark(s) or domain name(s).

In embodiments, the system may run periodically, on demand, continuously, or however user demand and system resources permit. In embodiments, the system is updated on a daily basis, and the search is tiered so that the most relevant information is presented to the user immediately and then the rest of the other extensions and possible variations, that are “less likely” to produce relevant results, are searched for that night and the system is then updated accordingly.

In operation, the customer domain name database, which may include customer domain names to be monitored is queried by the software to generate domain variations. As described above, the software to create domain variations may create complex domain variations. Those generate domain variations are checked against the domain name database and if a match is found, the user may be alerted according to a predetermined method.

In embodiments, a user may be alerted by e-mail, SMS, smartphone alert, or any other mechanism. In embodiments, an alert may be combined with notification on the user's dashboard.

In embodiments, the system may provide an interactive graphical user interface for receiving alerts, managing domain names and brands, The screen shots contained in Appendix A demonstrate examples of the alerting and dashboard systems.

In embodiments, a user logging into the system may be provided with the option to register variations of the domain name or trademark. Such registration may be made directly through the present system and preferably, without the user leaving the present system.

In embodiments, a user may be provided with the option to automatically register for the TMCH and may do so without leaving the confines of the present system. In embodiments, users may be able to access the system of the present invention to monitor the status of their TMCH registrations, and be able to interact with the TMCH via the system.

In embodiments, the system of the present invention may incorporate additional information about the user's intellectual property from sites such as the United States Patent and Trademark Office, Office for Harmonization in the Internal Market, or the like.

### EXAMPLE

An exemplary program flow for an embodiment of the system will now be described, which is meant only to be an example and is in no way limiting. Alternate program flows are contemplated as coming within the scope of the invention.

1. Each day, compressed zonefiles for various TLDs are retrieved from their respective domain registrars by the zonefile retrieval process, and stored in the zonefile holding area for the next processing step. The zonefile parsing process uncompresses the data on the fly, and looks for nameserver records which indicate that the domain referred to is registered and active. For each unique domain found, an entry is made in the SLD hashtable for the corresponding TLD, to indicate an active domain.

2. Several days' worth of zonefile hashtables are cached at any one time. In the event of a problem with the hashtables generated for a particular day, a manual process can select a previous day's hashtable or hashtables for use.

3. After all the zonefiles have been read, they are moved to the zonefile archive volume for long-term storage and possible subsequent use for other analysis. An expiration process deletes zonefile hashtables that are more than a few days old, to conserve disk space.

4. Each day after the zonefile parsing and SLD hashtable creation process, the matching process runs. It retrieves all domains from the customer data SQL database. For each domain, the TLD portion of the domain is removed, leaving the SLD for subsequent processing. A series of variations of the SLD are generated. The particular variations generated may differ depending on the contents of the SLD string, or on automatically-generated or manually-entered data hints, including but not limited to keywords related to the customer's area of business.

5. For each variant, a lookup is done in all SLD hashtables. Any match that has not been previously found is recorded as an alert for the user to review.

6. The variant and matching process is also run interactively for each new domain entered by a user. The process is tweaked as needed to run more quickly for interactive use.

7. The application server is used to host a model-view-controller-based application, which allows administrators and users to interact with the system.

8. A content management system is used to host a marketing website which supports sales and marketing activities related intake and support of users who use the application running on the application server.

### CONCLUSION

It will be understood that there are numerous modifications of the illustrated embodiments described above which will be readily apparent to one skilled in the art, such as many variations and modifications of the compression connector assembly and/or its components including combinations of features disclosed herein that are individually disclosed herein, explicitly including additional combinations of such features, or alternatively other types of contact array connectors. Also, there are many possible variations in the materials and configurations. These modifications and/or combinations fall within the art to which this invention relates and are intended to be within the scope of the invention. It is noted, as is conventional, the use of a singular element is intended to cover one or more of such an element.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

The term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media and magnetic media.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “searching,” “determining,” “calculating,” “obtaining,” “transmitting,” “receiving,” “querying,” “processing,” or the like, refer to the actions and processes of a computing device, or similar electronic computing device, that manipulates and transforms data represented as physical (e.g., electronic) quantities within the computing device's registers and memories into other data similarly represented as physical quantities within the computing device memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The above description sets forth numerous specific details such as examples of specific systems, components, methods and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth above are merely exemplary. Particular implementations may vary from these exemplary details and still be contemplated to be within the scope of the present invention.

It is to be understood that the above description is intended to be illustrative and not restrictive. Many other embodiments will be apparent to those of skill in the art upon reading and understanding the above description.

We claim:

1. A computer-implemented method for monitoring domain name registrations comprising:
generating a domain name data structure and writing said domain name data structure on a server computing device;
receiving a target name from a remote computing device;
generating a plurality of variations of said target name;
determining, using an application server computing device, whether any entries in said active domain name data structure qualify as a match to said target name; and
delivering results to said remote computing device over a network connection.

2. The method of claim 1 where in said step of generating an active domain name data structure comprises the steps of:
receiving one or more zone files over a network connection;
parsing said zone files to identify active domain names in said zone files; and
transferring said list of active domain names to a server computing device.

3. The method of claim 1 wherein said domain name data structure is a hash table.

4. The method of claim 1 wherein said domain name data structure is a database.

5. The method of claim 1 wherein said determining step incorporates data concerning the usage of said target name.

6. The method of claim 1 wherein said step of generating a plurality of variations comprises consideration of one of: characters in proximity to those of said target name, swapped characters, multiples of single characters in said target name, singles of multiple letters in said target name, and transposed letters.

7. The method of claim 1 wherein said step of generating a plurality of variations utilizes an artificial intelligence module.

8. The method of claim 7 wherein said artificial intelligence module is a part of said application server.

9. The method of claim 1 wherein said application server computing device generates an alert in response to said determining step.

10. The method of claim 1 wherein said application server computing device presents said alert to a user in the form of an interactive dashboard that includes additional information concerning said results.

11. The method of claim 10 wherein said additional information includes one of: an image of the current landing page for each of said results, a malware threat assessment concerning each of said results, and the registrant of each of said results.

12. A domain name registration monitoring system comprising:
a domain name data structure stored on a server computing device;
an application server computing device in communication with a remote computing device, wherein said application server computing device is configured to receive a target name from said remote computing device over a network; and
a processor for comparing entries in said domain name data structure with variations of said target name.

13. The system of claim 12 wherein said domain name data structure is a hash table.

14. The system of claim 12 wherein said domain name data structure is a database.

15. The system of claim 12 wherein said variations include one of: characters in proximity to those of said target name, swapped characters, multiples of single characters in said target name, singles of multiple letters in said target name, and transposed letters.

16. The system of claim 12 wherein said processor is connected to an artificial intelligence module.

17. The system of claim 12 wherein said processor is a part of said application server.

18. The system of claim 12 wherein said processor generates an alert in response to comparisons between said domain name data structure and said variations of said target name.

19. The system of claim 12 wherein said application server computing device generates an interactive dashboard that includes additional information concerning each of said results.

20. The system of claim 12 wherein said additional information includes one of: an image of the current landing page for each of said results, a malware threat assessment concerning each of said results, and the registrant of each of said results.

21. A domain name registration monitoring system comprising:
means for generating a domain name data structure and writing said domain name data structure on a server computing device.;
means for receiving a target name from a remote computing device;
means for generating a plurality of variations of said target name;
means for determining whether any entries in said active domain name data structure qualify as a match to said target name; and
means for delivering results to said remote computing device over a network connection.
